(19) United States
(12) Patent Application Publication
(10) Pub. No.: US 2025/0140123 A1
(43) Pub. Date: May 1, 2025

(54) TACTICAL DECONFLICTION SYSTEM FOR UNMANNED AERIAL VEHICLES

(71) Applicant: Zipline International Inc., South San Francisco, CA (US)

(72) Inventors: Ryan Oksenhorn, South San Francisco, CA (US); Divya Budihal, South San Francisco, CA (US); Anurag Makineni, South San Francisco, CA (US); Vasumathi Raman, South San Francisco, CA (US); Alexander Moldonado, South San Francisco, CA (US); Aaron D. Weinstein, Boulder, CO (US)

(21) Appl. No.: 18/835,809

(22) PCT Filed: Feb. 3, 2023
(86) PCT No.: PCT/US2023/012302

§ 371 Date: Aug. 5, 2024

Related U.S. Application Data
(60) Provisional application No. 63/306,614, filed on Feb. 4, 2022.

(51) Int. Cl. G08G 5/80; G05D 1/633; G05D 109/20

(52) U.S. Cl. CPC G08G 5/80; G05D 1/633; G05D 2109/20

(57) ABSTRACT

A method described herein includes receiving. by a first aircraft. flight information corresponding to a second aircraft within a range of the first aircraft. determining a time to intersection of the second aircraft with respect to the first aircraft based on the flight information of the second aircraft. determining an adjustment for the first aircraft based on the time to intersection of the second aircraft with respect to the first aircraft. and altering the path of the first aircraft based on the adjustment.

### CROSS-REFERENCE TO RELATED APPLICATIONS

This application claims priority to U.S. Provisional Patent Application No. 63/306,614, filed Feb. 4, 2022, entitled “DECONFLICTION SYSTEM FOR UNMANNED AERIAL VEHICLES”, which is incorporated herein by reference in the entirety and for all purposes.

### BACKGROUND

Unmanned aerial vehicles (UAVs) may be used to deliver various goods, including medical and other time-sensitive supplies. Such UAVs can be particularly helpful in rural areas, where time-sensitive deliveries are otherwise difficult or impossible. Flying as many UAVs as possible in a given area is often desirable to increase available deliveries in the given area. However, keeping numerous UAVs at a safe distance from one another (e.g., to avoid intersection) is difficult.

### SUMMARY

An example method described herein includes receiving, by a first aircraft, flight information corresponding to a second aircraft within a range of the first aircraft, where the flight information is transmitted from the second aircraft, determining a time to intersection of the second aircraft with respect to the first aircraft based on the flight information of the second aircraft, determining an adjustment for the first aircraft based on the time to intersection of the second aircraft with respect to the first aircraft, and altering the path of the first aircraft based on the adjustment.

In some examples, the adjustment may include an adjustment to an altitude of the first aircraft.

In some examples, the adjustment may include an adjustment to an airspeed of the first aircraft.

In some examples, the adjustment may include two or more of an adjustment to an airspeed of the first aircraft, an adjustment to a lateral location of the first aircraft, and an adjustment to an altitude of the first aircraft.

In some examples, determining a time to intersection includes analyzing possible trajectories and flight times of the second aircraft and utilizing a fastest time that the second aircraft will intersect with the first aircraft as the time to intersection.

In some examples, the method may further include receiving, by the first aircraft, flight information corresponding to a third aircraft within the range of the first aircraft, determining a time to intersection of the third aircraft with respect to the first aircraft based on the flight information of the third aircraft, and where the adjustment is further determined based on the time to intersection of the third aircraft with respect to the first aircraft.

In some examples, receiving flight information includes receiving a first information packet including a first time stamp and a first vehicle identifier, where the first information packet is received directly from the second aircraft, receiving a second information packet including a second time stamp and a second vehicle identifier, where the second information packet is received indirectly from the second aircraft, determining that the first vehicle identifier and the second vehicle identifier are the same and correspond to the second aircraft, comparing the first time stamp and the second time stamp to determine which of the first time stamp or the second time stamp is more recent, based on the first time stamp being more recent, utilizing the first information packet as the flight information or based on the second time stamp being more recent, utilizing the second information packet as the flight information.

In some examples, determining the adjustment may further include determining a threat level of the second aircraft with respect to the first aircraft and a threat level of the third aircraft with respect to the first aircraft, where the adjustment is further based on a comparison of the threat level of the second aircraft to the threat level of the third aircraft.

In some examples, receiving the flight information of the second aircraft may include receiving a line of sight radio transmission from the second aircraft to the first aircraft.

In some examples, the time to intersection of the second aircraft with respect to

the first aircraft may include a time until intersection of a first boundary of a first safety zone associated with the first aircraft and one of the second aircraft and a second boundary of a second safety zone associated with the second aircraft.

Example non-transitory computer readable media are encoded with instructions which, when executed by one or more processors of a flight controller of a first aircraft, cause the flight controller to receive flight information corresponding to a second aircraft within a range of the first aircraft, determine a time to intersection of the second aircraft with respect to the first aircraft based on the flight information of the second aircraft, determine an adjustment for the first aircraft based on the time to intersection of the second aircraft with respect to the first aircraft, and alter the path of the first aircraft based on the adjustment.

In some examples, the adjustment includes an adjustment to an altitude of the first aircraft.

In some examples, the adjustment includes an adjustment to an airspeed of the first aircraft.

In some examples, the adjustment includes one or more of adjustment to an airspeed of the first aircraft, an adjustment to a lateral location of the first aircraft, and an adjustment to an altitude of the first aircraft.

In some examples, the instructions may further cause the flight controller to receive flight information corresponding to a third aircraft within the range of the first aircraft, determine a time to intersection of the third aircraft with respect to the first aircraft based on the flight information of the third aircraft, and where the adjustment is further determined based on the time to intersection of the third aircraft with respect to the first aircraft.

In some examples, the instructions may further cause the flight controller to determine the adjustment by determining a threat level of the second aircraft with respect to the first aircraft and a threat level of the third aircraft with respect to the first aircraft, where the adjustment is further based on a comparison of the threat level of the second aircraft to the threat level of the third aircraft.

In some examples, the instructions may further cause the flight controller to receive the flight information of the second aircraft by receiving a line of sight radio transmission from the second aircraft to the first aircraft.

In some examples, the time to intersection of the second aircraft with respect to

the first aircraft may be a time until intersection of a first boundary of a first safety zone associated with the first aircraft and one of the second aircraft and a second boundary of a second safety zone associated with the second aircraft.

An example method for tactical deconfliction of an aircraft includes receiving, by the aircraft, flight information corresponding to a second aircraft within a range of the aircraft, determining a time to intersection of the second aircraft with respect to a boundary of a safety area surrounding the first aircraft, determining an adjustment for the aircraft based on the determined time to intersection, and altering the path of the first aircraft based on the adjustment.

In some examples, the method may further include receiving, by the aircraft, flight information corresponding to a third aircraft within the range of the aircraft, determining a time to intersection of the third aircraft with respect to the boundary of safety surrounding the aircraft, and where the adjustment is further determined based on the time to intersection of the third aircraft with respect to the first aircraft.

In some examples, the adjustment includes one or more of an adjustment to an airspeed of the aircraft, an adjustment to a lateral location of the aircraft, and an adjustment to an altitude of the aircraft.

In some examples, receiving the flight information of the second aircraft includes receiving a vehicle-to-vehicle transmission from the second aircraft to the aircraft.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1A illustrates an example view of a UAV in communication with a nearby UAV.

FIG. 1B illustrates an example view of a UAV making an altitude adjustment based on communications with nearby UAVs.

FIG. 1C illustrates an example view of a UAV making an airspeed adjustment based on communications with nearby UAVs.

FIG. 2 is a schematic diagram of an example UAV in accordance with particular embodiments.

FIG. 3 is a schematic diagram of an example computer system implementing various embodiments in the examples described herein.

FIG. 4 is a flow diagram of an example method of deconfliction for UAVs.

### DETAILED DESCRIPTION

The use of UAVs to deliver goods may shorten delivery times, reduce human intervention in deliveries, and save costs. Generally, UAVs may be deployed from an origin (e.g., a warehouse or retail location) with a flight plan to fulfill an order by delivering one or more items or products to a delivery area. Such flight plans may not account for other UAVs along the flight path. Further, UAVs may be deployed at the same time, with Accordingly, the UAVs may communicate with each other while in the air to ensure that the UAVs are adequately spaced to avoid intersection of flight paths of the UAVs while flying along the flight path. For example, UAVs may exchange location and velocity information and one or more of the UAVs may adjust their respective altitudes and/or airspeed along their flight paths to maintain distance between the UAVs.

Maintaining distances between UAVs may be referred to herein as deconfliction. Deconfliction allows many UAVs to be deployed in one area without the UAVs colliding with one another and without operator intervention during flight. Additional details of deconfliction are described with respect to the figures below.

As used herein, a UAV may be an aircraft with no pilot or other people on board (e.g., carrying cargo and unpiloted), a ground piloted aircraft, an aircraft carrying passengers but operated using autopilot, or a crewed aircraft operated partially using autopilot or other automatic control features. The systems and techniques described herein may also be used for traditional piloted aircraft.

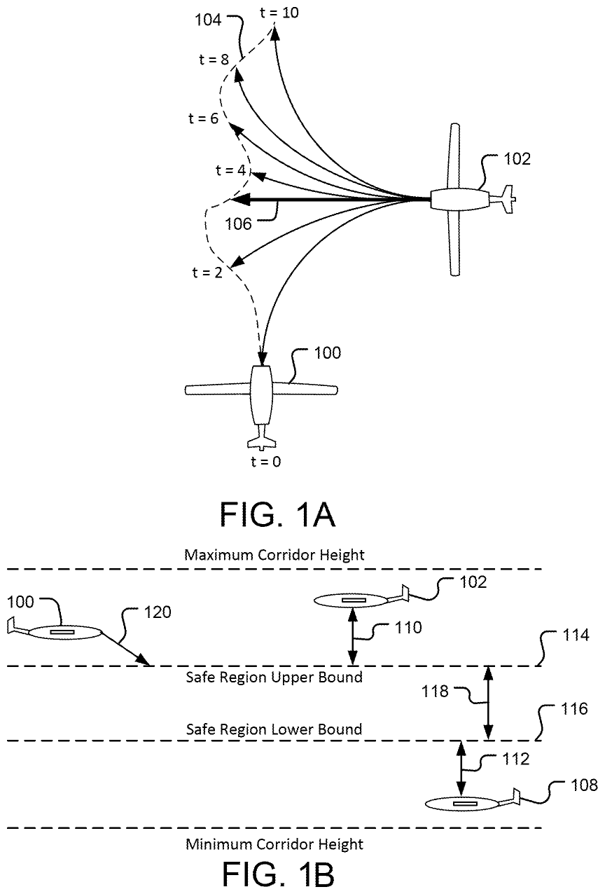

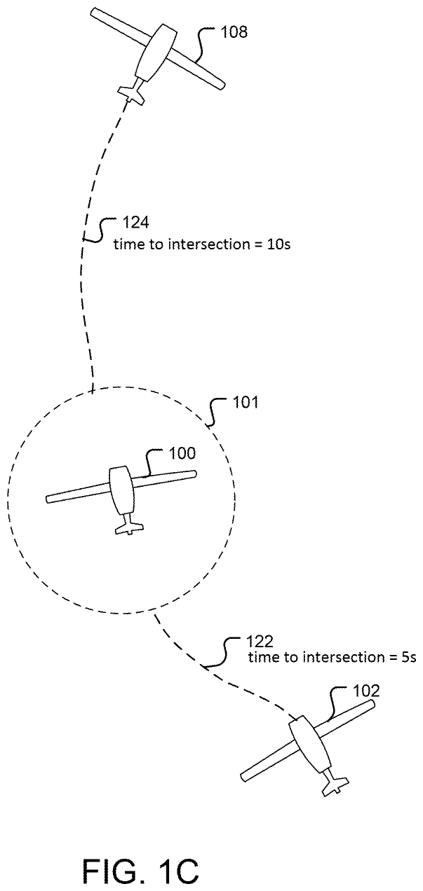

FIG. 1A illustrates an example view of a UAV 100 in communication with a nearby UAV 102. The UAV 100 may be moving along a flight path 104 and may detect the nearby UAV 102 when the nearby UAV 102 is within a communication range of the UAV 100. The UAV 100 and the UAV 102 may each be equipped with a communication system configured for communication between UAVs. The communication system may be implemented, in various implementations, by one or more of line of sight radio, cellular communication systems, satellite communication systems, and the like.

In various examples, the UAV 100 and the UAV 102 may exchange flight information when within a range of one another (e.g., 200 m to 1000 m or 600 to 700 m). This information may come directly or indirectly from the respective UAV, e.g. UAVE to UAV or UAV to communication component, such as a cloud server, and then relayed to the other UAV. Flight information may include a current location of the UAV, velocity of the UAV, and other information about the UAV and/or flight characteristics of the UAV. Location of the UAV may include location in three dimensions. In some examples, where different types (e.g., models) of UAVs are deployed in an area, a model number or other identifier of a UAV may be received with flight information, as the model number or other identifier may be used to make judgments and/or predictions about the flight of the UAV.

Once flight information is exchanged between the UAV 100 and the UAV 102, each of the UAV 100 and the UAV 102 may compute or determine a threat level of the other UAV. Though the threat level determination is described herein with respect to UAV 100 computing a threat level of the UAV 102, the UAV 102 may perform similar computations to determine a threat level of the UAV 100. Further, additional UAVs may be present in the range of the UAV 100. The UAV 100 may, accordingly, compute or determine a threat level for each UAV in its range after receiving flight information from the UAVs in its range. The threat level may be determined, at least in part, by a dynamics model that takes characteristics input from the UAV (e.g. flight speed, altitude, weight, etc.) that assess behavior of the UAV and determine various possible trajectories based on the characteristics.

The UAV 100 generally flies along a flight path 104. The flight path 104 may be defined, in various examples, by the latitude and longitude of the UAV 100 and a flight corridor including a range of altitudes at which the UAV 100 may fly. After receiving flight information from the UAV 102, the UAV 100 may break the flight path 104 into time increments (e.g., 2 second increments as shown in FIG. 1A) and calculate a time to intersection or “worst case” with respect to the UAV 102 at each increment. Such calculations may be done without knowing and/or referencing a flight path of the UAV 102. As the UAV 102 may change course while in the air (e.g., due to order cancellation, changing weather conditions, avoidance of other aircrafts or obstacles, etc.), predicting the position of the UAV 102 based on its flight path may be inaccurate. Accordingly, the UAV 100 determines how the UAV 102 may move from its current position to a position near to or intersecting the flight path 104. In some examples, the UAV 100 may calculate how quickly the UAV 102 may arrive at that point of the flight path 104 (e.g., time to intersection with the other UAV 102) based on the position and velocity of the UAV 102. How quickly the UAV 102 may arrive at that point of the flight path 104 may be referred to as a time to intersection. In some examples, the UAV 100 may also calculate how far from the flight path 104 the UAV 102 may be when the UAV 100 is at that point on the flight path 104. For example, based on the flight information of the UAV 102, the UAV 100 may determine that, when the UAV 100 is at the point on the flight path 104 marked by t=2, the UAV 102 can be, at closest, 50 m away from the flight path 104. In determining how far from the flight path 104 the UAV 102 may be at a point in time, the UAV 100 may assume that the UAV 102 can change its velocity (e.g., by changing direction, slowing down, or speeding up) within technical capabilities of the UAV 102.

The threat level may be calculated using the time to intersection and/or distances from the flight path 104 calculated for each time increment along the flight path 104. For example, where the UAV 100 calculates that the UAV 102 will be close to, or intersecting with, the flight path 104 at several of the time increments, the threat level may be high. Where the UAV 100 calculates that the UAV 102 will not intersect the flight path 104 at any of the time increments and the UAV 102 will be relatively far from the flight path 104 at those time increments, the threat level may be low. The threat level may be used to determine how to adjust the path of the UAV 100, including where multiple other UAVs are within range of the UAV 100. In such examples, adjustments of the UAV 100 may be selected to move farther away from UAVs with a higher calculated threat level.

FIG. 1B illustrates an example view of a UAV 100 making an altitude adjustment based on communications with nearby UAVs 102 and 108. The altitude adjustment may be made after determining a threat level for each of the UAVs 102 and 108. As shown in FIG. 1B, multiple UAVs 100, 102, and 104 may be flying within a flight corridor defined as a band between a minimum corridor height and a maximum corridor height. To avoid the UAV 102 (e.g. stay within a safety perimeter) and the UAV 108, the UAV 100 may calculate a safe region 118, defined by a lower bound 116 and an upper bound 114. These bounds may be set by altitude and/or lateral position or may be defined by a volumetric area. When the altitude of the UAV 100 is within the safe region 118, the UAV 100 is more than a minimum safe distance from both the UAV 102 and the UAV 108. For example, the safe region upper bound 114 may be determined to provide a minimum distance 110 between the UAV 102 and the safe region 118. The minimum distance 110 may be equal to the shortest desirable or allowable distance between the UAV 100 and the UAV 102. Similarly, the safe region lower bound 116 may be determined to provide a minimum distance 112 between the UAV 108 and the safe region 118. The minimum distance 112 may be equal to the shortest desirable or allowable distance between the UAV 100 and the UAV 108. The altitude adjustment of the UAV 100 includes changing the altitude of the UAV 100 such that the UAV 100 is within the safe region 118. For example, the UAV 100 may determine a path 120 to follow to navigate the UAV 100 into the safe region 118. In some examples, an altitude adjustment may be made in addition to an airspeed adjustment.

FIG. 1C illustrates an example view of a UAV 100 making an airspeed adjustment based on communications with nearby UAVs. Airspeed adjustments may be helpful for spacing out UAVs when there are many UAVs in an area, such as when multiple UAVs are engaged in a holding pattern waiting to land at the same location. Airspeed adjustments may be used to change a lateral position of the respective UAV. In some examples, airspeed adjustments may be made in addition to altitude adjustments, which change the height of the UAVs, to space out UAVs. Airspeed adjustments may also be used without altitude adjustments when UAVs are unable to change altitude and/or an altitude adjustment would not further space the UAVs.

The view shown in FIG. 1C may be an overhead view, showing a UAV 102 behind the UAV 100 and a UAV 108 in front of the UAV 100. The UAV 102 and/or the UAV 108 may be at a similar altitude to the UAV 100 or may be at an altitude less than a threshold or minimum distance from the UAV 100. After receiving flight information from the UAV 102 and the UAV 108, the UAV 100 may determine that the UAV 102 is a behind neighbor, meaning that the UAV 102 is following a similar path (e.g., appears to be headed in the same direction) as the UAV 100. The UAV 100 may further determine that the UAV 108 is a front neighbor, meaning that the UAV 100 is following a similar path to the UAV 108. Where there are multiple UAVs following similar paths to the UAV 100, the UAV 100 may locate the closest behind neighbor and the closest front neighbor to calculate an airspeed adjustment.

As shown in FIG. IC, in various examples, one or more UAVs may be associated with a safety area or safety volume, which may be defined by a boundary around the UAV. For example, a safety area may be a spherical volume around the UAV. Safety zones may, in other examples, be different shapes, such as rectangular prisms, irregularly shaped volumes, and the like. In the example, of FIG. 1C, UAV 100 is associated with a safety area 101. In these examples, the time to intersection may be a time to a second UAV entering the safety area of a first UAV or a time to the safety area of the second UAV intersecting with the safety area of the first UAV.

Such safety areas may be used to provide additional buffer around UAVs and increase the tolerance for the threat calculations. The safety areas may be omitted or can be varied to increase or decrease based on various inputs or restraints. For example,, the safety areas may be influenced or selected based on local regulations. For example, some regulations set by air traffic regulators (e.g. the Federal Aviation Administration) may set a minimum spacing required between UAVs, and the size of the safety areas may be chosen to comply with such regulations. The size of the safety areas may further vary based on other factors such as type of UAV, size of UAV, weather, and other factors. For example, for UAVs with sophisticated communication and/or manuevuring systems, the minimum spacing may be smaller as compared to slower and/or less communicative UAVs as the slower or less communicative UAVs may not be able to respond as quickly to changes in position, which require a larger spacing to ensure safety and reduce intersections between vehicles. Defining intersection of UAVs as being intersection of the safety areas of the UAVs may accordingly reduce the chance of intersection of the physical UAVs while keeping the UAVs in compliance with applicable regulations, in various examples. For example, the time to intersection may be a time until two UAVs are within a minimum distance allowed by an applicable regulation.

After identifying the behind neighbor 102 and the front neighbor 108 (and/or top and bottom neighbors in some instances), the UAV 100 may calculate a time to intersection for both the behind neighbor 102 and the front neighbor 108. Like the calculations described with respect to FIG. 1A, the UAV 100 may use the flight information of the behind neighbor 102 to determine the least amount of time it would take the behind neighbor 102 or a boundary of a safety area of the behind neighbor 102 to intersect with the UAV 100 or the boundary of the safety area 101 of the UAV 100. The time to intersection for the front neighbor 108 may be calculated based on the flight information of the front neighbor 108 by determining when the UAV 100 or the boundary of the safety area 101 would reach the front neighbor 108 or a boundary of a safety area of the front neighbor 108 at its current airspeed if the front neighbor 108 were to slow down. In such examples, both times to intersection represent the shortest time to intersection between the UAV 100 and neighboring UAVs 102 and 108 or the shortest time to intersection of the boundary of the safety area 101 of the UAV 100 and either the UAVs 102 and 108 or the boundaries of safety zones of the neighboring UAVs 102 and 108.

In various examples, the time to intersection may be determined using dynamics models representative of the UAVs 108 and 102 near the UAV 100. For example, the UAV 100 may create and/or utilize dynamics models of the motions of the UAVs 108 and 102. The dynamics model may utilize information, such as UAV characteristics (including both flight characteristics and mechanical/system characteristics of the UAVs) to determine a possible range of motions and/or trajectories that the respective UAV may take. These may be, for example, how quickly the UAV could swerve or change directions or altitude, and then can be extrapolated to determine the time to intersection. For example, the time to intersection may be determined using the “worst” outcome from such dynamics model. A worst outcome for a dynamics model of the UAV 102 may, for example, represent the fastest that the UAV 102 could possibly reach the UAV 100 (or the boundary of the safety zone 101), given the current dynamics of the UAV 102. For example, if the UAV 102 were to suddenly change course and turn directly towards the UAV 102, how quickly would an intersection occur, this could be used as the worst case scenario even if a more gradual change in lateral positioning is more likely.

While some scenarios may use the more likely dynamics modeling, in instances where the system utilizes the worst or fastest intersection time for the threat assessment, helps to increase safety and account for unexpected movement by a particular UAV. For example, utilizing the fastest intersection times helps to account of instances where the UAV 102 may need to change its flight path rapidly to avoid another intruder or obstacle. The dynamics model may account for various factors such as current speed and direction of the UAV 102, speed and direction of wind surrounding the UAV 102, maneuvering capabilities of the UAV 102, and the like and be configured to determine possible trajectories, time to traverse the trajectories, and the like.

The UAV 100 may determine an airspeed adjustment based on the calculated time to intersection for the behind neighbor 102 and the front neighbor 108. In some examples, the airspeed adjustment may be based on a ratio of the time to intersection of the front neighbor 108 to the time to intersection of the behind neighbor 102. For example, in FIG. 1C, a ratio of the time to intersection of the front neighbor 108 to the time to intersection of the behind neighbor 102 is 2:1, meaning that the airspeed adjustment should cause the UAV 100 to move closer to the front neighbor 108, increasing the time to intersection of the behind neighbor 102. In other scenarios, where the UAV 100 is closer to a front neighbor than to a behind number (e.g., the ratio of time to intersection of the front neighbor to time to intersection of the rear neighbor is less than 1), the airspeed adjustment should cause the UAV 100 to slow down, allowing the front neighbor 108 to space out further from the UAV 100. In some examples, the UAV 100 may continue to receive flight information from the UAV 102 and the UAV 108 while the UAV 102 and the UAV 108 are within a communication range of the UAV 100 and may continually make airspeed adjustments to maintain spacing between the UAV 100 and the UAVs 108 and 102.

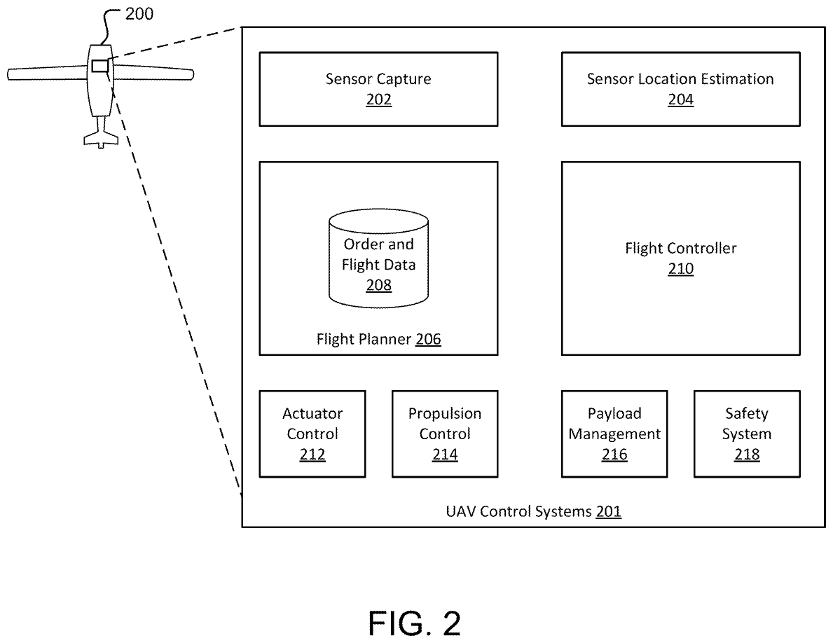

FIG. 2 is a schematic diagram of an example UAV 200 in accordance with particular embodiments. The UAV 200 comprises UAV control systems 201, including a communications system 202 and a sensor system 204. A flight planner 206 may receive information from the communications system 202 and the sensor system 204 and use the information to create or update a flight path for the UAV 200 using order and flight data 208. The flight planner 206 may communicate the updated flight plan to a flight controller 210, which may communicate with actuator control 212, propulsion control 214, payload management 216, and a safety system 218 to execute the flight plan for the UAV 200.

The UAV control systems 201 may be implemented be various hardware modules. In some implementations, various components of the UAV control systems 201 may be combined into a single component and the UAV control systems 201 may be implemented by any number of hardware components including system on chip (SOC) hardware, various processors, controllers, and programmable logic. Various hardware modules may be interconnected by a communications bus, which may be implemented using a Controller Area Network (CAN) standard. In some implementations, some modules of the UAV control systems 201, such as the flight planner 206, may be implemented using computing resources not located within the UAV 200.

A communications system 202 may comprise transmitters and receivers that enable the UAV 102 to send and receive information using various communications protocols. For example, the communications system 202 may include transmitters and receivers for code division multiple access (CDMA), global system for mobile communications (GSM), various cellular standards (e.g., 3G/4G/5G), long-term evolution (LTE), WiFi, Bluetooth, satellite communication, and/or custom line of sight and mesh protocols that may allow the UAV 200 to communicate with other UAVs. Communication between UAVs may also use cellular communications, satellite communications, or other types or combinations of types of communications. The communications system 202 may include transmitters and receivers for such other types of communications, in various examples. The sensor system 204 may include various sensors configured to gather different types of information about the environment of the UAV 200. For example, the sensor system 204 may include a global positioning system (GPS), inertial measurement unit (IMU), dynamic pressure sensors, static pressure sensors, air temperature sensors, proximity sensor, and other sensors.

Control systems of the UAV 200 may include, for example, actuator control 212, propulsion control 214, payload management 216, and a safety system 218. The actuator control system 212 may include actuators that control various moving parts of the UAV 200, such as rudders, elevators, and other control structures of the UAV 200. The actuator control system 212 may change the state of actuators on the UAV 200 and may report the current state of any actuators to other components of the UAV control systems 201.

Propulsion control 214 may control force exerted by any engines included in the UAV 200 (e.g., by adjusting the speed of propellers mounted on a propeller powered UAV). Propulsion control 214 may also monitor an amount of fuel or battery power remaining on the UAV 200. Payload management 216 generally performs functions related to the payload (e.g., items of a customer order) transported by the UAV 200. Payload management 216 may monitor the state (e.g., orientation, temperature) of the payload and controls release of payload.

A flight controller 210 may store the flight plan and provide instructions to control systems of the UAV 200 execute the flight plan. The flight controller 210 may receive data from the communications system 202 and the sensor system 204 to continuously compute the location, speed, and heading of the UAV 200. The flight controller 210 may combine location information with the flight plan and determine what, if any, changes or adjustments may be made to keep the UAV 200 on a path specified in the flight plan. For example, the flight controller 210 may compute waypoints for the UAV 200 to fly from an origin to a destination and compute orientation and propulsion to move the UAV 200 to a next waypoint. The flight controller 210 may then send commands to other modules of the UAV control systems 201, such as the actuator control 212 and the propulsion control 214 to take action to adjust the orientation and speed of the UAV 200.

The flight controller 210 may continuously calculate an estimated position, orientation, and speed of the UAV 200 using state estimation based on information received from other components of the UAV control systems 201. For example, the flight controller 210 may perform state estimation using engine state information from the propulsion control 218, actuator state information from actuator control 212, and information from various sensors of the sensor system 204. The flight controller 210 may then determine appropriate adjustments for propulsion and actuation for the UAV 200 to continue moving along a path defined in the flight plan.

The flight controller 210 may further calculate threat levels and/or times to

intersection for UAVs near the UAV 200, determine adjustments of the path (e.g., altitude and/or airspeed adjustments) of the UAV 200 to carry out tactical deconfliction, and communicate with actuator control 212 and/or propulsion control 214 to carry out airspeed and/or altitude adjustments for deconfliction. The flight controller 210 may further communicate with the communication system 202 to send flight information for the UAV 200 to nearby UAVs and/or to receive flight information from nearby UAVs to perform deconfliction operations.

A flight planner 206 may use order and flight data 208 to generate and update flight plans to fulfill orders using the UAV 200. The flight planner 206 may be implemented by computing systems apart from the UAV control systems 201 or may be implemented at the UAV 200 as part of the UAV control systems 201. For example, in one implementation, the flight planner 206 is implemented by cloud computing resources in communication with the UAV control systems 201 via a network. In some implementations, the flight planner 206 may be implemented by computing systems located at distribution location within a distribution network or at a centralized control location. In either implementation, the flight planner 206 is in continuous communication with the UAV 200. Similarly, the order and flight data 208 may be located at the UAV 200, at a storage location apart from the UAV 200 (e.g., cloud storage or a flight control database) or at a combination of locations.

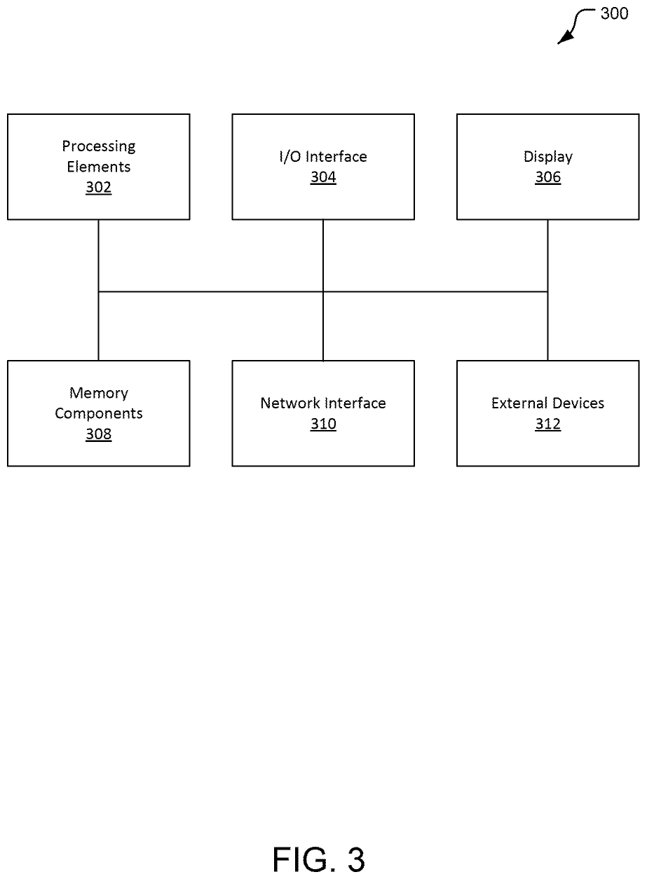

FIG. 3 is a schematic diagram of an example computer system 300 for implementing various embodiments in the examples described herein. A computer system 300 may be, for example, integrated into one or more components of the UAV control systems 201. For example, the flight planner 206 may include one or more of the components of the computer system 300 shown in FIG. 3. In FIG. 3, the computer system 300 may include one or more processing elements 302, an input/output interface 304, a display 306, one or more memory components 308, a network interface 310, and one or more external devices 312. Each of the various components may be in communication with one another through one or more buses, communication networks, such as wired or wireless networks.

The processing element 302 may be any type of electronic device capable of processing, receiving, and/or transmitting instructions. For example, the processing element 302 may be a central processing unit, microprocessor, processor, or microcontroller. Additionally, it should be noted that some components of the computer 300 may be controlled by a first processor and other components may be controlled by a second processor, where the first and second processors may or may not be in communication with each other.

The memory components 308 are used by the computer 300 to store instructions for the processing element 302, as well as store data, such as order and flight data 208 (FIG. 2) and the like. The memory components 308 may be, for example, magneto-optical storage, read-only memory, random access memory, erasable programmable memory, flash memory, or a combination of one or more types of memory components.

The display 306 provides visual feedback to a user, such as a display of a user device in communication with one or more UAVs. Optionally, the display 306 may act as an input element to enable a user to communicate with a UAV (e.g., to monitor the UAV, to configure a flight plan for the UAV, and/or to transmit other instructions to the UAV). The display 306 may be a liquid crystal display, plasma display, organic light-emitting diode display, and/or other suitable display. In embodiments where the display 306 is used as an input, the display may include one or more touch or input sensors, such as capacitive touch sensors, a resistive grid, or the like.

The I/O interface 304 allows a user to enter data into the computer 300, as well as provides an input/output for the computer 300 to communicate with other devices or services (e.g., a UAV 100 and/or other components in FIG. 1). The I/O interface 304 can include one or more input buttons, touch pads, and so on.

The network interface 310 provides communication to and from the computer 300 to other devices. For example, the network interface 310 allows the control systems 201 of the UAV 200 to communicate with other UAVs and/or with user devices through a communication network. The network interface 310 includes one or more communication protocols, such as, but not limited to WiFi, Ethernet, Bluetooth, and so on. The network interface 310 may also include one or more hardwired components, such as a Universal Serial Bus (USB) cable, or the like. The configuration of the network interface 310 depends on the types of communication desired and may be modified to communicate via Wifi, Bluetooth, and so on.

The external devices 312 are one or more devices that can be used to provide various inputs to the computing device 300, e.g., mouse, microphone, keyboard, trackpad, or the like. The external devices 312 may be local or remote and may vary as desired. In some examples, the external devices 312 may also include one or more additional sensors.

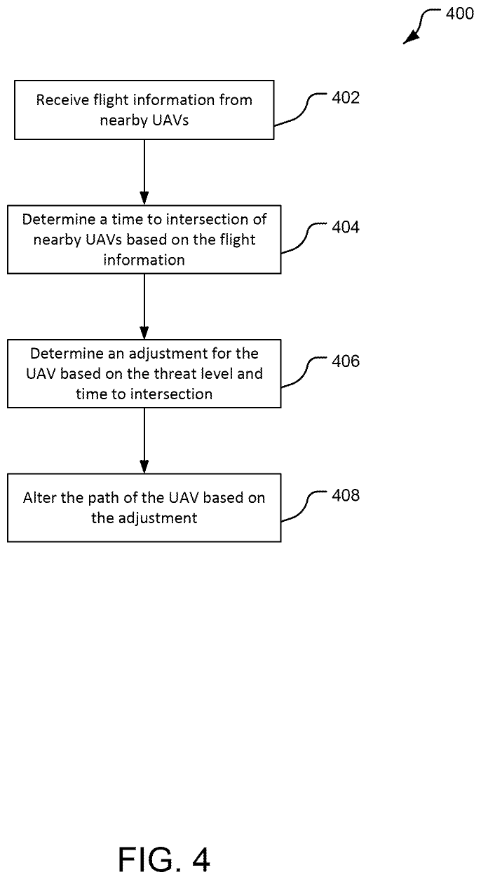

FIG. 4 is a flow diagram of an example method of deconfliction for UAVs. At block 402, a UAV 200 (e.g, at UAV control systems 201) receives flight information from nearby UAVs. For example, flight information may be received at one or more receivers of the communications system 202 of the UAV 200. The UAV 200 may receive flight information from all UAVs within a particular range. In some examples, the range may be defined by a communication range of the system used to UAV to UAV communication. For example, where UAVs communicate using line of sight radio communications, the line of sight radio may have a range of 700 m, and the UAV 200 may receive flight information for UAVs within 700 m of the UAV 200. In other examples, the range may be predefined by a user. For example, where many UAVs are expected to be in a particular area, the range may be shortened (e.g., to 500 m) such that the deconfliction method focuses on the UAVs closest to the UAV 200.

In various examples, the UAV 200 may receive flight information for surrounding UAVs using other methods of vehicle-to-vehicle (V2V) or other communications. For example, receiving flight information via line of sight may be a type of V2V communication, where all UAVs may continually broadcast flight information over the radio frequency to be received by any other UAVs in range. In some examples, the UAV 200 may further or instead receive flight information from a centralized or remote location. For example, UAVs may provide flight information to a centralized repository (e.g., using satellite or other wireless protocols), and the UAV 200 may receive such flight information for UAVs within a defined range from the centralized location.

In some examples, the UAV 200 may receive flight information both from V2V communications and from a centralized location. In these examples, the centralized location may provide redundancy in the case of problems with the V2V communication. In such examples, the UAV 200 may receive flight information for another UAV from both V2V communications from the other UAV and from the centralized location. Such flight information may be time stamped such that the UAV 200 may determine which flight information is the most recent or up-to-date. The UAV 200 may then utilize the most recent flight information for deconfliction. For example, a first information packet may be received including a first identifier indicating that the information corresponds to a particular UAV and may include a time stamp for when the information was transmitted from the particular UAV and a second information packet may be received that may include a time stamp for when the information was received and a second identifier indicating the particular UAV from which it was sent.

The UAV 200 may receive both the first and second information packets and analyze the identifier information to determine that both information packets are from the same UAV (but may have been received via separate modalities, e.g. the first one may be received directly from the particular UAV through V2V and the second one may be received indirectly from the UAV, such as through a cloud connection communicatively coupled to both UAVs). Based on determining that the two information packets are the same, the UAV may then utilize the time stamps to select the most recent time stamp as the time stamp for the dynamics model. By utilizing the one that is the most recently transmitted from the UAV, which may not necessarily be the most recent information packet received, the UAV 200 can use the most up to date information regarding the particular UAV's flight information.

Flight information may include, for example, a current location of a UAV and velocity information (e.g., airspeed and direction of travel) for the UAV. In some examples, all UAVs may broadcast flight information over the communication system such that all UAVs within range of the UAV receive its flight information at a time interval (e.g., every 2 seconds). In some examples, the UAV 200 may detect nearby UAVs and request, over the communication system, flight information for the detected UAVs. In various examples, the UAV 200 may further transmit its flight information over the communication system at block 402.

The UAV 200 determines a time to intersection of nearby UAVs based on the flight information at block 404. The time to intersection may be determined by, for example, the flight controller 210 of the UAV control systems 201. As described with respect to FIGS. 1B and IC, time to intersection may be calculated based on how quickly other UAVs may arrive to points on the flight path of the UAV 200 and/or when the UAV 200 may catch up to another UAV, such as a front neighbor, by following along its flight path.

The UAV 200 may calculate one or more times to intersection for each nearby UAV. For example, as shown in FIG. 1A, the UAV 200 may break its flight path into time increments and calculate a time to intersection for each increment along the flight path for a nearby UAV. In other scenarios, such as for behind and front neighbor UAVs, the UAV 200 may calculate one time to intersection for the neighboring UAV. Various times to intersection may be computed without knowing a planned flight path for each nearby UAV. Because UAVs may move or vary from flight paths for various reasons (e.g., weather conditions, commercial aircraft, entering a holding pattern), time to intersection may be more accurately calculated without relying on planned flight paths of nearby UAVs.

At block 406, the UAV 200 determines an adjustment for the UAV based on the time to intersection. The adjustment may include an altitude adjustment and/or an airspeed adjustment, depending on the number of UAVs nearby, location of the nearby UAVs, the time to intersection of the nearby UAVs, and/or the threat level of the nearby UAVs. In some examples, such as for airspeed adjustments, the UAV 200 may determine an adjustment based on time to intersection of nearby UAVs. For example, the UAV 200 may compute a ratio of a time to intersection of a behind neighbor to a time to intersection of a front neighbor to determine how to adjust airspeed.

In some examples, the UAV 200 may calculate or determine a threat level of each nearby UAV based on the time to intersection and may determine the adjustment based on the threat level of nearby UAVs. For example, the UAV 200 may prioritize, with its adjustments, moving farther from a high threat level nearby UAV, even when doing so moves closer to another, lower threat level UAV. For example, as shown in FIG. 1B, the UAV 100, when moving to the safe region 118, moves closer to the UAV 108 in order to move at least a distance 110 from the UAV 102, which has a higher threat level with respect to the UAV 100 than the UAV 108.

The UAV 200 may also determine both an airspeed adjustment and an altitude adjustment using both threat levels and time to intersection. For example, the UAV 200 may have a front neighbor and a behind neighbor and may use time to intersection to determine how to adjust airspeed with respect to the front neighbor and the behind neighbor. The UAV 200 may also calculate a threat level for the front neighbor and the behind neighbor and may, when possible, determine an altitude adjustment in addition to the airspeed adjustment. The altitude and/or airspeed adjustments may further be based on the locations of many (e.g., 10 or 20) nearby UAVs.

In some examples, the adjustment calculation may be based on a cost function, and the cost function may account for additional factors in addition to nearby UAVs. For example, the cost function may take into account intruding commercial aircraft, ground-based obstacles (e.g., power lines or tall buildings), weather, airspace restrictions, and the like in addition to threat levels and time to intersection for nearby UAVs. Using the cost function, the UAV 200 may determine a “best” (e.g., lowest cost) maneuver given each of the factors taken into consideration by the cost function.

The UAV 200 alters its path based on the adjustment at block 408. The flight controller 210 may utilize the calculated adjustment to provide instructions to other components of the UAV control systems 201 to effectuate the adjustment. For example, the flight controller 210 may provide instructions to actuator control 212 to make an altitude adjustment by adjusting control surfaces of the UAV 200. The flight controller 210 may further provide instructions to propulsion control 214 to change airspeed of the UAV 200.

In some examples, the UAV 200 may return to block 402 of the method 400 after the initial adjustment to maintain spacing from nearby UAVs. As all or most UAVs in the area may be using the method 400 for tactical deconfliction, UAVs may inadvertently move closer to one another in an attempt to avoid one another. In such situations, each of the UAVs may detect that the UAVs have moved closer together and one UAV may, on the next iteration, move with respect to the other UAV. Various tie breaking methods may be used to determine which UAV moves. For example, an identification number or other arbitrary marker may be used as a tie breaker. In some examples, some UAVs may be designated as “leader” UAVs and may have a higher priority in such situations. Further, the continual adjustment of UAVs with respect to nearby UAVs using the method 400 generally allows the UAVs in a given area to maintain spacing between one another and avoid intersection between areas of safety of the UAVs, even given flight path changes of some or all of the UAVs.

In accordance with the above description, the tactical deconfliction methods described herein allow for deployment of more UAVs in various areas, providing more access to deliveries of supplies, goods, and the like to the areas. Further, the deconfliction methods allow for the continuous autonomous operation of the UAVs, as the UAVs are able to conduct most or all tactical deconfliction without operator input. The deconfliction methods are also failure tolerant. For example, should one UAV lose communications, other UAVs nearby will continue to perform tactical deconfliction to avoid the UAV with lost communication.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A method comprising:
receiving, by a first aircraft, flight information corresponding to a second aircraft within a range of the first aircraft, wherein the flight information is transmitted from the second aircraft;
determining a time to intersection of the second aircraft with respect to the first aircraft based on the flight information of the second aircraft;
determining an adjustment for the first aircraft based on the time to intersection of the second aircraft with respect to the first aircraft; and
altering the path of the first aircraft based on the adjustment.

2. The method of claim 1, wherein the adjustment comprises at least one of an adjustment to an altitude of the first aircraft or an adjustment to an airspeed of the first aircraft.

3. The method of claim 1, wherein the adjustment comprises two or more of an adjustment to an airspeed of the first aircraft, an adjustment to a lateral location of the first aircraft, and an adjustment to an altitude of the first aircraft.

4. The method of claim 1, wherein determining a time to intersection comprises analyzing possible trajectories and flight times of the second aircraft and utilizing a fastest time that the second aircraft will intersect with the first aircraft as the time to intersection.

5. The method of claim 1, further comprising:
receiving, by the first aircraft, flight information corresponding to a third aircraft within the range of the first aircraft;
determining a time to intersection of the third aircraft with respect to the first aircraft based on the flight information of the third aircraft; and
wherein the adjustment is further determined based on the time to intersection of the third aircraft with respect to the first aircraft.

6. The method of claim 5, wherein determining the adjustment further comprises determining a threat level of the second aircraft with respect to the first aircraft and a threat level of the third aircraft with respect to the first aircraft, wherein the adjustment is further based on a comparison of the threat level of the second aircraft to the threat level of the third aircraft.

7. The method of any of claim 1, wherein the flight information is transmitted directly from the second aircraft to the first aircraft.

8. The method of claim 1, wherein receiving the flight information of the second aircraft comprises receiving a line of sight radio transmission from the second aircraft to the first aircraft.

9. The method of claim 1, wherein the time to intersection of the second aircraft with respect to the first aircraft comprises a time until intersection of a first boundary of a first safety zone associated with the first aircraft and one of the second aircraft and a second boundary of a second safety zone associated with the second aircraft.

10. The method of claim 1, wherein receiving the flight information further comprises:
receiving a first information packet including a first time stamp and a first vehicle identifier, wherein the first information packet is received directly from the second aircraft;
receiving a second information packet including a second time stamp and a second vehicle identifier, wherein the second information packet is received indirectly from the second aircraft;
determining that the first vehicle identifier and the second vehicle identifier are the same and correspond to the second aircraft;
comparing the first time stamp to the second time stamp to determine which of the first time stamp or the second time stamp is more recent; and
based on the first time stamp being more recent, utilizing the first information packet as the flight information or based on the second time stamp being more recent, utilizing the second information packet as the flight information.

11. One or more non-transitory computer readable media encoded with instructions which, when executed by one or more processors of a flight controller of a first aircraft, cause the flight controller to:
receive flight information corresponding to a second aircraft within a range of the first aircraft, wherein the flight information is transmitted from the second aircraft to the first aircraft either directly or indirectly;
determine a time to intersection of the second aircraft with respect to the first aircraft based on the flight information of the second aircraft;
determine an adjustment for the first aircraft based on the time to intersection of the second aircraft with respect to the first aircraft; and
alter the path of the first aircraft based on the adjustment.

12. The one or more non-transitory computer readable media of claim 11, wherein the adjustment comprises an adjustment to either or both an altitude of the first aircraft or an adjustment to an airspeed of the first aircraft.

13. The one or more non-transitory computer readable media of claim 11, wherein the adjustment comprises one or more of an adjustment to an airspeed of the first aircraft, an adjustment to a lateral location of the first aircraft, and an adjustment to an altitude of the first aircraft.

14. The one or more non-transitory computer readable media of claim 11, wherein a dynamics model utilizing characteristics of the second aircraft it utilized to determine a time to intersection.

15. The one or more non-transitory computer readable media of claim 11, wherein the instructions further cause the flight controller to:
receive flight information corresponding to a third aircraft within the range of the first aircraft;
determine a time to intersection of the third aircraft with respect to the first aircraft based on the flight information of the third aircraft; and
wherein the adjustment is further determined based on the time to intersection of the third aircraft with respect to the first aircraft.

16. The one or more non-transitory computer readable media of claim 15, wherein the instructions cause the flight controller to determine the adjustment by determining a threat level of the second aircraft with respect to the first aircraft and a threat level of the third aircraft with respect to the first aircraft, wherein the adjustment is further based on a comparison of the threat level of the second aircraft to the threat level of the third aircraft.

17. The one or more non-transitory computer readable media of claim 11, wherein the instructions cause the flight controller to receive the flight information of the second aircraft by receiving a line of sight radio transmission from the second aircraft to the first aircraft.

18. The one or more non-transitory computer readable media of claim 11, wherein the time to intersection of the second aircraft with respect to the first aircraft comprises a time until intersection of a first boundary of a first safety zone associated with the first aircraft and one of the second aircraft and a second boundary of a second safety zone associated with the second aircraft.

19. A method for tactical deconfliction of an aircraft, the method comprising:
receiving, by the aircraft, flight information transmitted from a second aircraft within a range of the aircraft;
determining a time to intersection of the second aircraft with respect to a boundary of a safety area surrounding the first aircraft;
determining an adjustment for the aircraft based on the determined time to intersection; and
altering the path of the first aircraft based on the adjustment.

20. The method of claim 17, further comprising:
receiving, by the aircraft, flight information corresponding to a third aircraft within the range of the aircraft;
determining a time to intersection of the third aircraft with respect to the boundary of safety surrounding the aircraft; and
wherein the adjustment is further determined based on the time to intersection of the third aircraft with respect to the first aircraft.

21. The method of claim 17, wherein the adjustment comprises one or more of an adjustment to an airspeed of the aircraft, an adjustment to a lateral location of the aircraft, and an adjustment to an altitude of the aircraft.

22. The method of claim 17, wherein receiving the flight information of the second aircraft comprises receiving a vehicle-to-vehicle transmission from the second aircraft to the aircraft.
